(19) United States
(12) Patent Application Publication
(10) Pub. No.: US 2007/0010596 A1
(43) Pub. Date: Jan. 11, 2007

(54) Plasma-Polymerized Hydrogel Thin Films and Methods for Making the Same

(75) Inventors: Dennis W. Hess, Atlanta, GA (US); Prabhakar A. Tamirisa, Atlanta, GA (US); Jere Koskinen, Munich (DE)

Correspondence Address: TROUTMAN SANDERS LLP, 600 PEACHTREE STREET , NE, ATLANTA, GA, 30308, US

(73) Assignee: GEORGIA TECH RESEARCH CORPORATION, Atlanta, GA (US)

(21) Appl. No.: 11/456,522

(22) Filed: Jul. 10, 2006

Related U.S. Application Data
(60) Provisional application No. 60/697,592, filed on Jul. 8, 2005.

(51) Int. Cl. G02B 1/04

(52) U.S. Cl. 523/106

(57) ABSTRACT

Plasma-polymerized hydrogel thin films and methods for making the same are provided. According to some embodiments of the present invention, plasma polymerization can be utilized to fabricate thermoresponsive hydrogel films of N-isopropylacrylamide (NIPAAm) on a substrate in a single deposition step. For example, an embodiment of the present invention includes fabricating a crosslinked polymeric structure utilized to form a thin film hydrogel. The polymeric structure fabrication method can comprise vaporizing a monomer and polymerizing the monomer using a plasma reactor. Polymerizing the monomer can crosslink the monomer to form a polymer film, and the polymer film can be deposited onto a substrate. The crosslinked density of the polymeric structure can be varied or tailored by adjusting temperature, pressure, and power conditions within the plasma reactor. Other embodiments are also claimed and described.

### CROSS-REFERENCE TO RELATED PATENT APPLICATION

This application claims priority to and the benefit of U.S. Provisional Patent Application No. 60/697,592, filed 8 Jul. 2005, which is incorporated by reference in its entirety as if fully set forth below.

### TECHNICAL FIELD

The various embodiments of the present invention are directed generally to polymerized structures and associated fabrication techniques, and more particularly, to plasma-polymerized hydrogel thin films and processes for creating responsive, plasma-polymerized microstructures.

### BACKGROUND

Hydrogels are water-swollen crosslinked polymeric structures derived from hydrophilic monomers. Hydrogels are typically produced by the polymerization of one or more monomers and involve interactions, such as hydrogen bonding and strong Van der Waals interactions, between polymeric chains. Crosslink densities are built into the structures either during polymerization by incorporating free radical crosslinking agents or by radiation exposure after polymerization. Polymeric networked structures are generally glassy in the absence of water and have properties similar to those of other glassy polymers.

When crosslinked polymer networks are exposed to water, they can absorb water up to several times their own weight. The hydrophilic nature of the individual monomers allows water absorption and the crosslinked network-like structure of hydrogels retards release of the absorbed waters. Uncrosslinked polymers synthesized from hydrophilic monomers may simply dissolve in water resulting in non-stable materials. The absorbed water improves the plasticity of the polymer network and provides gel like qualities to the polymer yielding a hydrogel.

Hydrogels can have various properties. For example, thermoresponsive hydrogels such as N-isopropylacrylamide (NIPAAm), 2-hydroxl ethyl methacrylate (HEMA), and acrylic acid (AA) can demonstrate thermoshrinking or lower critical solution transition (LCST) behavior: a hydrophilic and swollen state at temperatures below LCST and a hydrophobic and collapsed state above LCST. Affixing thermoshrinking polymers in a thin film form on a solid support allows expansion and contraction essentially only in a direction perpendicular to a substrate relative to a temperature change. Temperature-sensitive hydrogel structures can be used for sensor and actuator applications and intelligent surfaces in biotechnology and medicine.

Conventional methods have attempted to study effects of lateral confinement, of hydrogel films and possible applications. The majority of these conventional methods involve preparation of hydrogel films using a solution-based, free-radical polymerization or photopolymerization that necessitate the use of a crosslinker. Using crosslinkers (or crosslinking agents), however, increases the number of utilized chemicals, thus increasing process complexity and cost. Further, unreacted crosslinking agents have to be leached out of the polymer network thereby increasing process complexity. In addition, forming thin film hydrogels using these conventional methods typically requires an extra step, spin casting. Spin casting is not advantageous because it is difficult to form uniform thin films especially when the film material is highly viscous and of a high molecular weight (e.g. polymers and hydrogels).

Other conventional hydrogel fabrication methods include methods that use a volumetric plasma reactor. In a volumetric plasma reactor, thin film formation and associated properties are generally determined by reactions in a volume of plasma, which does not allow good control of ion bombardment nor temperature of the growing film, thereby limiting control of the ability to tailor film properties. Similarly, a volumetric plasma reactor allows relatively little control of crosslink density.

Conventional hydrogel formation techniques also have several other drawbacks. For example, hydrogel film adhesion to a substrate is one such drawback. Indeed, NIPAAm films are prone to delamination and are not stable in aqueous environments, thus hindering film characterization and use in aqueous media. Adhesion limitations of NIPAAm films to silicon surfaces have been approached in various ways. For example, anchoring NIPAAm chains to a surface using covalent linkages has been a common approach. An adhesion promoter based on a monochlorosilane anchor group and a chromophore head group have been used to overcome poor adhesion of NIPAAm to silicon. Other silane-based surface pretreatments have also been reported, such as γ-methacryloxypropyl trimethoxysilane, 3-aminopropyl triethoxysilane, vinyl triethoxysilane, and (N,N′-diethylamino)dithiocarbamoyl propyl-(triethoxy) silane. In addition, NIPAAm brushes have been grafted to hydroxyl terminated alkylthiolate monolayers on gold surfaces. While serving their respective purposes, these solutions are not advantageous because they increase the number of chemicals and process steps thereby leading to increased complexity and utilize chemicals that are not environmentally benign.

Accordingly, there is a need for hydrogels and methods for producing hydrogels that provide simple production methods capable of producing hydrogels having improved adhesion qualities and the ability to tailor and control hydrogel crosslink densities. It is to the provision of such hydrogel and hydrogel fabrication methods that the various embodiments of present invention are directed.

### BRIEF SUMMARY

The various embodiments of the present invention provide novel hydrogel and hydrogel fabrication methods utilizing various features of plasma polymerization processes. Embodiments of the present invention can be used to fabricate thin (e.g., nanometer) films on a variety of substrates utilizing a plasma polymerization process thereby producing hydrogel structures that can be used for sensor, actuator, and intelligent surface applications. For example, plasma polymerized NIPAAm thin films formed from a method embodiment of the present invention may range in thickness from approximately 10 nanometers (nm) to approximately 400 nm. In addition, a method embodiment of the present invention may form ultra-thin films (i.e., less than approximately 50 nm) with good uniformity. Generally, other thin film forming methods such as spin casting can form thicker films (thickness up to 5-8 (micrometers) μm); however, such methods cannot form ultra thin films (<50 nm) with good uniformity.

Some embodiments of the present invention can be used to vary or adjust certain plasma reactor process parameters to tailor the molecular chemical and physical properties through variation of crosslink density. Still yet some embodiments of the present invention can be used to reduce manufacturing costs associated with hydrogel fabrication, eliminate environmentally harmful chemicals, and increase hydrogel fabrication output for large scale manufacturing.

Broadly described, a method to fabricate a crosslinked polymeric structure comprises vaporizing a monomer and using plasma to polymerize and crosslink the monomer. The resulting polymer can form a polymer film having a tailored crosslink density. That is, crosslink density can be varied intentionally to achieve particular film properties appropriate for specific film applications. The method can further comprise varying temperature, pressure, and power conditions associated with polymerizing and crosslinking to form the polymer film.

A method can also comprise other conditions or processes. For example, a method can comprise diluting the vaporized monomer using argon, oxygen, nitrogen, anhydrous ammonia, hydrogen, or a combination thereof. The monomer can comprise at least one of acrylates, acrylamides, acetates, acrylic acids, vinyl alcohols, and glycols. Further, the monomer can comprise at least one of ethylene glycol, acrylic acid, tetraethyleneglycol dimethylether, and N-isopropylacrylamide.

Plasma can be generated in various manners according to embodiments of the present invention. For example, plasma can be generated using a parallel-plate, capacitively-coupled, radio-frequency (RF) plasma reactor. The plasma reactor can be operated in a frequency range of about 0.5 megahertz (MHz) to about 30 MHz and in a power range of about 25 Watts (W) to about 35 W. Other reactor types and operating conditions may also be utilized. Further, polymerization and crosslinking of the monomer can occur at a temperature greater than a vaporization temperature of the monomer. The plasma can be pressurized in a pressure range of about 93.3 Pa (Pa) to about 133.3 Pa. Other pressure conditions may also be used.

In another embodiment of the present invention, a crosslinked polymeric structure fabrication method comprises providing a plasma reactor and introducing plasma within the reactor to deposit a crosslinked polymer film having a tailored crosslink density onto a substrate. The tailored crosslink density may fall above or below a specific amount, may be relative to another formed polymer film, and can be tailored to produce more or less crosslinking, as desired. The method may also include activating the substrate to facilitate adhesion of the crosslinked polymer film to the substrate. Activating the substrate can include exposing the substrate to plasma to pretreat the substrate for film deposition.

Still yet, a method can include varying process conditions associated with the plasma reactor to form the crosslinked polymer film having the tailored crosslink density. Such varied process conditions can include a plasma reactor power factor, a plasma reactor pressure factor, a plasma reactor temperature factor, and a substrate temperature factor. The reactor temperature factor can be different from the substrate temperature factor. The crosslinked polymer film can be exposed to a liquid to produce a responsive hydrogel or a responsive organogel adhered to a substrate, depending on the monomer used to manufacture the hydrogel or organogel. In one embodiment, for example, the crosslinked polymer film is exposed to an aqueous substance to produce a responsive hydrogel. The hydrogel can be adhered to the substrate such that it does not dissolve or otherwise wash away. The method can also include controlling the tailored crosslink density of the polymer film by altering one or more operating parameters associated with the plasma reactor.

According to still yet another embodiment, a crosslinked polymeric structure fabrication method can comprise forming a polymer film by polymerizing a vaporized monomer such that the polymer film is crosslinked and depositing the polymer film onto a substrate located within a reactor. A method can also include varying conditions within the reactor to control a crosslink density associated with the polymer film. The variable conditions within the reactor can comprise a temperature range of between about 120° C. to about 200° C., a pressure range of between about 93.3 Pa to about 133.3 Pa, and a power input of about 30 W. Other operating conditions may also be utilized. Also, the polymer film can form a hydrogel that is reversibly temperature dependent or a hydrogel having a lower critical solution transition temperature ranging from approximately 9° C. to approximately 20° C.

Other aspects and features of embodiments of the present invention will become apparent to those of ordinary skill in the art, upon reviewing the following description of specific, exemplary embodiments of the present invention in conjunction with the accompanying figures.

### BRIEF DESCRIPTION OF THE FIGURES

FIG. 1 illustrates a flow diagram depicting a method to form a polymeric structure used to form a hydrogel according to some embodiments of the present invention.

FIG. 2 illustrates a schematic diagram of a polymeric structure fabrication system utilized in accordance with some embodiments of the present invention.

FIG. 3 illustrates a table depicting variable angle spectroscopic ellipsometry (“VASE”) results of NIPAAm films deposited on a silicon substrate obtained in accordance with some embodiments of the present invention.

FIG. 4 illustrates Fourier transform infrared (“FTIR”) spectra of NIPAAm films deposited on a silicon substrate in accordance with some embodiments of the invention.

FIG. 5 illustrates FTIR spectra of NIPAAm films deposited on silicon substrate in accordance with some embodiments of the present invention.

FIG. 6 illustrates a table displaying FTIR results of NIPAAm films deposited on a silicon substrate in accordance with some embodiments of the present invention.

FIGS. 7A-7D illustrate various contact angles of plasma-polymerized NIPAAm films deposited on a surface of a silicon substrate in accordance with some embodiments of the present invention.

### DETAILED DESCRIPTION OF PREFERRED & ALTERNATIVE EMBODIMENTS

Embodiments of the present invention can provide a single-step, plasma-polymerization deposition method to fabricate polymeric structures for use in forming hydrogel thin films. As those skilled in the art will understand, plasma polymerization is typically a solution-free technique that can be used to deposit highly networked thin films of hydrogel material without using crosslinkers. A feature of embodiments of the present invention includes the ability to tailor a hydrogel's crosslink density by utilizing certain reactor conditions. The ability to tailor film properties refers to the ability to control the film crosslink density or the film thickness uniformity. Uniformity refers to the spatial variation of thickness; a smaller variation in thickness across a sample correlates with more uniform film.

Indeed, when utilizing embodiments of the present invention, it is possible to construct a polymeric structure having a tailored crosslink density by varying certain plasma reactor process conditions such that crosslinking density is decreased or increased, as may be desired or required. For example, if a more crosslinked film is required, a higher temperature (say 175 C) and a lower pressure (93.3 Pa) may be utilized according to some embodiments of the present invention. In addition, positioning of materials within a plasma reactor can also enable variation of a polymeric structure's film thickness and composition according to some embodiments.

As discussed below in more detail, deposited films forming a hydrogel in accordance with embodiments of the present invention can have substrate adhesion characteristics that reduce washing away of a hydrogel attached to a substrate. Further, the hydrogel may possess responsive characteristics, such as being thermoresponsive.

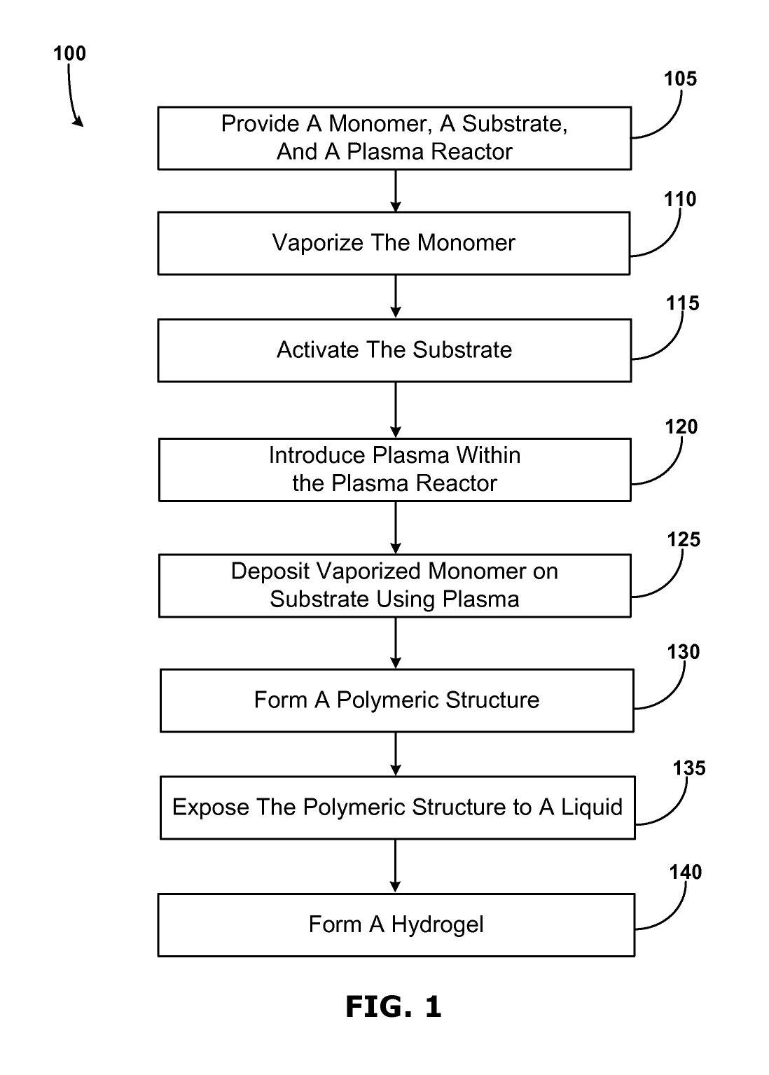

Referring now to the drawings, FIG. 1 illustrates a flow diagram depicting a method 100 to form a polymeric structure used to form a hydrogel according to some embodiments of the present invention. As those skilled in the art will understand, the method 100 is only one possible method according to some embodiments of the present invention, the method 100 may be carried with more or less process steps, and the method 100 may be implemented with various systems and devices. While the method 100 is discussed below as forming a single polymeric structure and a single hydrogel, it should be understood that the method 100 can be used to form a network of polymeric structures and, therefore, a network of hydrogels also.

As shown in FIG. 1, the method 100 initiates at 105 by providing a monomer, a substrate, and a plasma reactor. Various types of monomers may be used including, but not limited to, acrylates, acrylamides, acetates, acrylic acids, vinyl alcohols, glycols, ethylene glycol, acrylic acid, N-isopropylacrylamide, and combinations or derivatives thereof. As will be later discussed, monomers can be utilized to provide a hydrogel thin film in hydrogel fabrication. Various types of substrates may also be utilized. For example, sample substrates include quartz, glass, silicon, and metallic substrates, such as gold, aluminum, and platinum. A substrate is preferably used but may not be required according to some embodiments of the present invention.

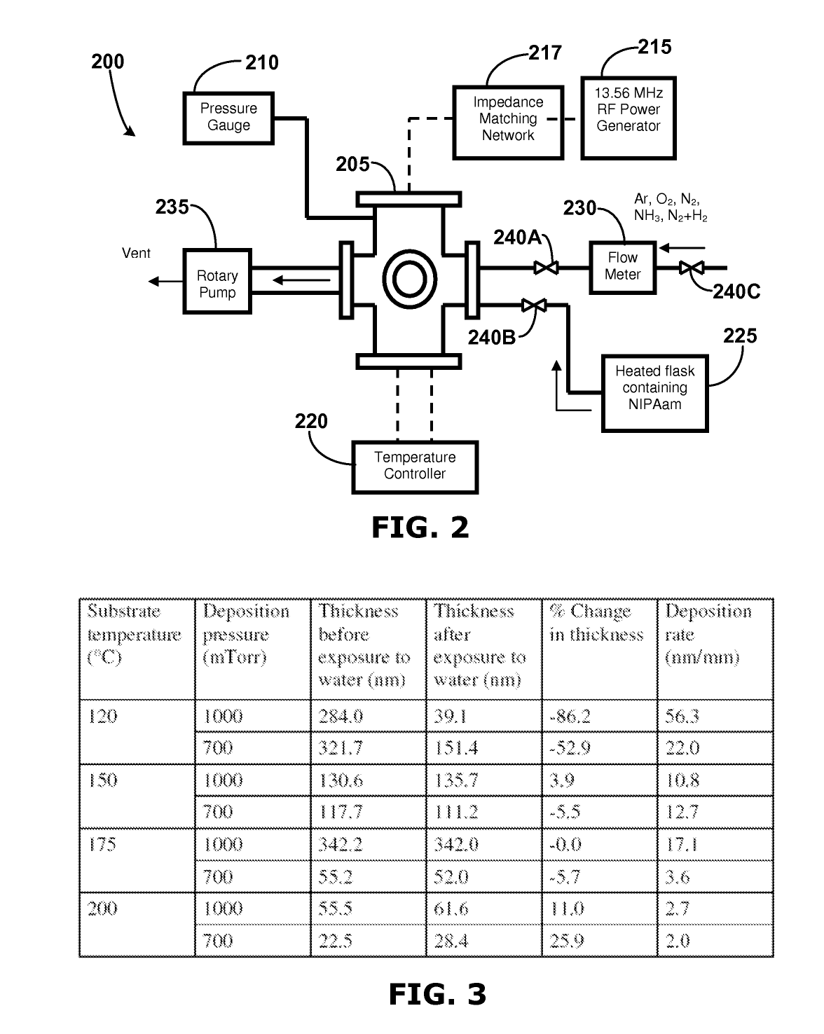

A plasma reactor is also used according to embodiments of the present invention, and an exemplary plasma reactor is discussed in more detail below with reference to FIG. 2. A plasma reactor enables a plasma polymerization process to occur, which can polymerize a monomer thereby crosslinking the monomer. As those skilled in the art will understand, certain portions of the method 100 can be implemented within a plasma reactor.

The method 100 continues at 110 by vaporizing a monomer. Monomer vaporization preferably takes place in a container or other equipment capable of containing a vaporized gas. While actual vaporization conditions (vaporization temperature and heating time) will depend on the monomer being vaporized, monomer vaporization should provide enough vaporized monomer to yield a desired amount of film for polymeric structure formation.

By way of example, the amount of monomer required depends on the fabrication quantity and thickness of the film desired. Thicker films may be prepared through plasma polymerization by carrying out the process for longer process times, and hence will require larger quantities of the monomer vapor. It is preferable to contain the vaporized monomer in a heated container, regulate flow of the vaporized monomer, and utilize a gas to assist in flowing and diluting the vaporized monomer when performing the method 100.

Once a monomer is adequately vaporized, a substrate is preferably activated at 115. Substrate activation can pretreat the substrate to facilitate bonding of a thin film on the substrate. Substrate activation may include exposing a surface of the substrate to plasma of a gas within a plasma reactor. Such gases include, but are not limited to, oxygen, anhydrous ammonia, argon, nitrogen, or a combination thereof.

After activating and preparing the substrate for deposition, plasma and the vaporized monomer can be introduced within the plasma reactor for deposition purposes at 120. For example, plasma can be introduced by applying RF power to a gas. Gases that may be utilized to provide plasma include, but are not limited to: oxygen, anyhydrous ammonia, argon, nitrogen, or a combination thereof. Substrate activation is preferably not performed with any gas that contains the monomer vapor.

The introduction of the RF power, the vaporized monomer, and gas within the plasma reactor initiates a plasma polymerization process. Due to the plasma polymerization process, the vaporized monomer is polymerized, crosslinked, and deposited on the surface of the substrate at 125. The plasma polymerization process is continued such that the deposition of the vaporized monomer forms a polymeric structure on the surface of the substrate at 130. It should be understood that formation of the polymeric structure may also include forming a network of polymeric structures.

Once a polymeric structure is formed within the plasma reactor, the method 100 continues to form a hydrogel. Typically, the substrate is first removed from the plasma reactor and then exposed to a liquid, such as an aqueous substance, at 135. During this exposure, the formed polymeric structure absorbs the liquid to yield a gel. For example, when the polymeric structure is exposed to water and absorbs water, a hydrogel is formed at 140. The absorption capacity of the hydrogel is determined by the physicochemical properties (such as crosslink density and hydrogen bonding characteristic) of the films which are typically dictated by the process conditions used to prepare them. As mentioned above, the method 100 can be implemented with various systems and devices, and an exemplary system is illustrated in FIG. 2.

FIG. 2 illustrates a schematic diagram of a polymeric fabrication structure system 200 utilized in accordance with some embodiments of the present invention. As shown the system 200 generally comprises a reactor 205, a pressure gauge 210, a power generator 215 and a temperature controller 220. The reactor 205 is preferably a parallel-plate, capacitively-coupled RF plasma reactor, however, other reactors may also be utilized. The reactor 205 is preferably controlled using a pressure gauge 210, a power generator 215 and a temperature controller 220 such that a reaction within the reactor 205 occurs at certain process condition. The power generator 215 preferably provides RF energy to the reactor in frequencies from about 0.5 MHz to about 30 MHz and more preferably in the range of about 13 MHz to about 14 MHz. The pressure gauge 210 and temperature controller 220 can be utilized to control reactor pressure and temperature such that these process conditions stay approximately equal to a desired amount or within a desire range. For examples pressures ranging from about 5 Pa (˜30 mTorr) to about 266.6 Pa (˜2 Torr) may be used and the substrate temperature may range from about 120° C. to about 200° C. Substrate temperature may be different from internal reactor temperature, and can be controlled with the temperature controller 220.

A feature of embodiments of the present invention is to control one or more of the temperature, pressure, and power process conditions to control polymeric structure fabrication within the reactor 205. Controlling reactor process conditions enables production of a polymeric structure having a tailored crosslink density such that more or less crosslinking results in formed polymeric structure. Embodiments of the present invention enable plasma polymerization of a monomer at low pressure and in a gas phase to obtain hydrogel thin films in a single-step, polemerization-deposition process. Indeed, the inventors have discovered (discussed in detail below) how to fabricate a polymeric structure with a desired cross link density.

The polymeric fabrication system 200 can also comprise other components. For example, an impedance matching network 217 may be employed to ensure efficient power transfer from the power generator 215 to the reactor 205. Other components can include a gas container 225 to contain a vaporized monomer, a flow meter 230, and a rotary pump 235. The flow meter 230 controls introduction of one or more gases from one or more gas sources used to provide plasma upon interaction with RF energy provided by the power generator 215. Gas flow rates may range from 20-100 standard cubic centimeters per minute (seem). Gas flow rates are determined on the basis of the deposition rate and thickness desired. The rotary pump 235 communicates with a vent and vents exhaust from within the reactor 205 to an external environment. The system 200 can also comprise multiple valves, such as valves 240A, 240B, and 240C, to control gas flow into and out of the reactor 205. These valves may be stop-cock valves, and additional valves or alternative valve types may also be utilized.

The polymeric fabrication system 200 enables a plasma polymerization process to occur within the reactor 205. For example, typically a substrate is placed within the reactor 205, a vaporized monomer contained within the gas container 225 is introduced within the reactor 205, and the power generator 215 provides RF power within the reactor 205 to interact with gas provided from the flow meter 230. The RF power interacts with the provided gas to form plasma. The plasma interacts with the vaporized monomer to polymerize and crosslink the monomer to form a polymer film. During the polymerization process, deposition of polymeric film on the substrate within the reactor occurs substantially simultaneously with the polymerization process. That is, the polymerization reaction can occur on the surface of the substrate, and substantially simultaneously form polymeric film on the surface of the substrate

The process conditions of the reactor can be varied and controlled to tailor the crosslink density of a formed polymeric structure. For example, the inventors have discovered that variations of pressure temperature, and power within the reactor 205 enable control over the crosslink density of a formed polymeric structure and an associated hydrogel when exposed to liquid. Substrate temperature can also be varied to aid in controlling and tailoring properties of a formed polymeric structure. Indeed, the inventors conducted several experiments illustrating control over the crosslink density associated with fabrication of polymeric structures and hydrogels, which in turn illustrated control over tailoring transition temperatures of hydrogels.

The above disclosure generally describes some embodiments of the present invention. A more complete understanding can be obtained by reference to the following examples and experimental results. These examples are described solely for purposes of illustration and are not intended to limit the scope of the various embodiments of the present invention. Although specific terms have been employed herein, such terms are intended in a descriptive sense and not for purposes of limitations.

### EXAMPLE 1

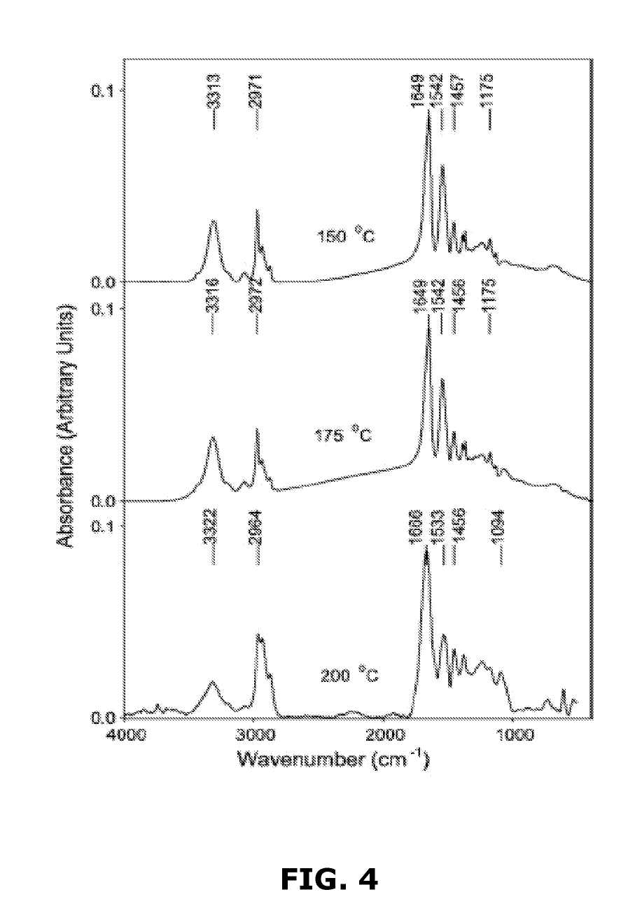

In a first example plasma-polymerized NIPAAm thin films were deposited oil a silicon substrate in a capacitivey-coupled, 13.56 MHz plasma reactor. As discussed above, FIG. 2 illustrates the schematic diagram of utilized polymeric structure fabrication system 200. After discussing the process and devices of Example 1, FIG. 3 is discussed as it contains a table depicting results associated with Example 1.

Prior to depositing the NIPAAm films, the surface of a substrate was activated by exposing it to an oxygen plasma for approximately one minute at approximately 133.3 Pa and approximately 30 W RF power. The substrate was maintained at the same temperature used for depositing the NIPAAm films. Four different substrate temperatures (approximately 120° C. 150° C., 175° C. and 200° C.) were used in this experiment. Prior to deposition, surface activation (or pretreatment) of the substrate created surface radicals and reduced organic contamination on the substrate surface, and thus enhanced or facilitated adhesion of the deposited NIPAAm films to the silicon substrate.

Since NIPAAm is a crystalline solid at ambient conditions it was vaporized by heating, 10 grams of the crystalline solid to approximately 110° C., in a glass storage flask. A threaded Teflon plug was used to regulate the introduction of NIPAAm vapor into gas delivery tubes. Stainless steel gas delivery tubes were maintained at approximately 90° C. using heating tapes to avoid vapor condensation. The vaporized NIPAAm monomer was diluted using argon with a ratio of approximately a 50:50 (equal parts) mixture.

After monomer vaporization and argon dilution, NIPAAm films were deposited at substrate temperatures of approximately 120° C., 150° C., 175° C. and 200° C., and pressures of approximately 93.3 Pa and 133.3 Pa. The deposited films were deposited to have a thickness of about 10 nm to about 400 nm. Thickness is varied by varying the time of deposition or the time of the plasma polymerization process (e.g., increasing the de position time increases the thickness of the film deposited). The resulting films were characterized with variable angle spectroscopic ellipsometry (VASE) (J.A. Woollam M-2000VI), contact angle measurements (FTA 32) and FTIR spectroscopy (Nicolet Magna-IR 560 spectrometer). Ellipsometry was also used to determine the film thickness before and after water exposure. FTIR spectroscopy permitted the determination of chemical bonding information before water exposure.

Contact angle measurements were performed using 18.0 MΩ-cm deionized water to determine the surface hydrophilicity/hydrophobicity of the formed NIPAAm films. Prior to contact angle measurements, NIPAAm samples were rinsed in deionized water three times to remove uncrosslinked monomer chains; excess water was removed by blow drying using compressed air. This procedure is also believed to hydrate the polymer structure which was crosslinked in the dry plasma state. Contact angle measurements were performed on a custom built thermoelectric heating/cooling stage. Temperature was controlled within a range of 0.2° C. using a board level Proportiona-Integral-Derivative temperature controller (Oven Industries 5C7-550).

The temperature controller used a thermistor to sense thermoelectric stage temperature. Independent confirmation of the temperature was obtained using a thermocouple. Although the thermocouple and thermistor probes were placed near the sample surface to minimize errors in measurement of the temperature of the sample surface, spatial temperature variations of up to approximately 2° C. were found on the thermoelectric stage. The thermocouple temperature readings had a linear correlation with the thermistor temperatures (R²=0.998), which allowed a simple calibration.

Contact angles were determined from spherical fits of images of approximately ten microliter drops of deionized water on the surface of NIPAAm films. Images of the sessile drops on the sample surface were recorded using a camera, which could be triggered immediately before the drop contacted the surface. By adjusting parameters on the software program used to control the syringe containing the deionized water and the camera, an image was captured each second for 120 seconds. In all cases, measured contact angles decrease from the time of initial contact of the water droplet with the hydrogel surface. The contact angles discussed below were recorded 60 seconds after the contacting the surface in most cases; at this point, the contact angle no longer changes with time. When sample temperature was greater than 32° C., droplet volume decreased drastically 10 seconds after the drop contacted the surface due to water evaporation. To ensure that the contact angles measured were those of sessile drops and not receding drops, the contact angles were recorded 10 seconds after the water drop contacted yhe surface. The contact angles reported are the average of at least three measurements at each temperature; all contact angles were recorded at a relative humidity value of approximately 40%.

FIG. 3 illustrates a table depicting variable angle spectroscopic ellipsometry (“VASE”) results of NIPAAm films deposited on a silicon substrate obtained in accordance with some embodiments of the present invention. Film thickness before and after exposure to water was determined using VASE and model fitting. Deposition rates in nm/min were calculated from the film thickness and deposition time, and these results are shown in FIG. 3.

Under all deposition conditions, a change in film thickness was observed after water exposure. Negative relative changes in thickness are caused by partial film dissolution or adhesion loss, while positive relative changes in thickness are due to film swelling. Lack of adequate crosslinking can cause dissolution of the films, since uncrosslinked hydrophilic chains of the polymer dissolve in water. Higher substrate temperatures and lower deposition pressures (higher ion bombardment energy) provide more highly crosslinked films, which may not show dissolution or adhesion loss. Lower substrate temperatures and higher deposition pressures provided less crosslinked films that may be prone to film dissolution. Thus, an optimum set of deposition conditions were discovered as shown by tabular data in FIG. 3. Films deposited at 200° C. and 93.3 Pa show the highest positive relative change in thickness, while films deposited at 120° C. and 133.3 Pa display the highest negative relative change in thickness.

FIG. 3's experimental results illustrate that substrate temperature variation controlled film chemistry in the plasma polymerization of 2-hydroxyethyl methacrylate, hexafluorobutadiene, ethylene oxide, and tetrahydrofuran. Lower substrate temperatures yield films with chemical composition identical to that of the monomer. At higher substrate temperatures the increased thermal energy of reactive species can result in greater bond scission and chemical reactivity. Lower pressure results in higher ion bombardment energy of the growing film surface and thus enhanced crosslinking.

Temperature of the substrate is controlled by a temperature controller. Different substrate temperatures are achieved by changing the setpoint of the temperature controller. It is important to note that substrate temperature may be different from the temperature within the reactor during plasma polymerization. The substrate temperature is a parameter that aids in determining the crosslinked polymeric film structure and consequently the hydrogel film properties. By way of example, the substrate temperature (and hence, of the growing thin film) is preferably controlled to obtain specific properties in the NIPAAm films (e.g. crosslink density). During the plasma polymerization process, temperature in the reactor is preferably higher than the vaporization temperature of the monomer to prevent condensation in the reactor.

Film deposition rate, which is a function of reactor conditions, is indicative of film properties. Indeed, the results shown in FIG. 3 demonstrate that at approximately 120° C. and approximately 133.3 Pa. NIPAAm films were deposited at a rate of approximately 56.3 nm/min. This rate was the highest rate observed, and as discussed above, these particular films showed the greatest reduction in thickness after water exposure. In comparison, films deposited at approximately 200° C. and approximately 93.3 Pa displayed the lowest deposition rate of 2.0 nm/min and showed the highest positive relative change in thickness upon water exposure.

### EXAMPLE 2

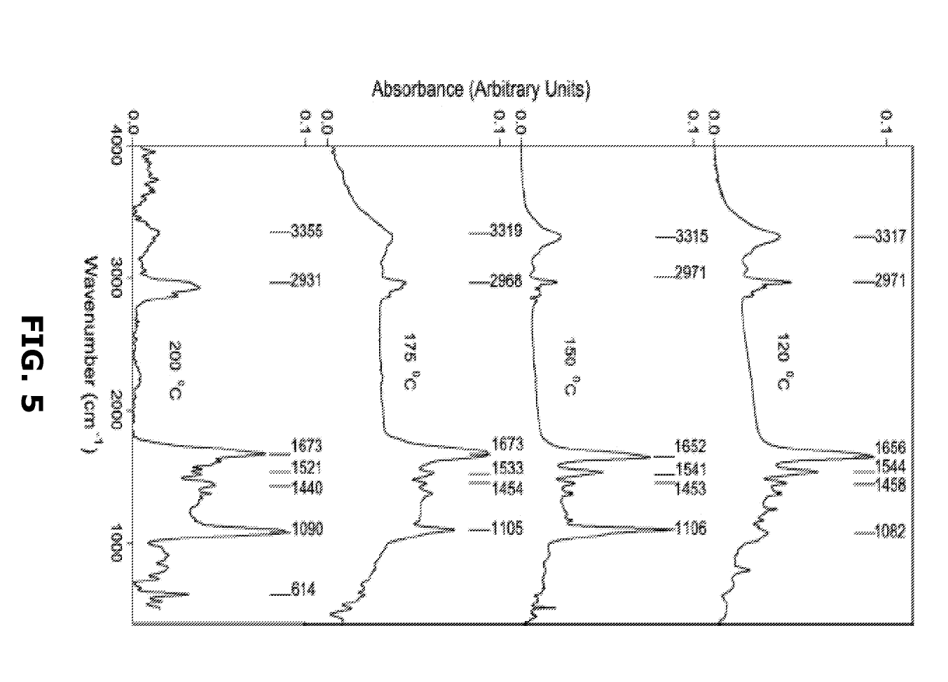

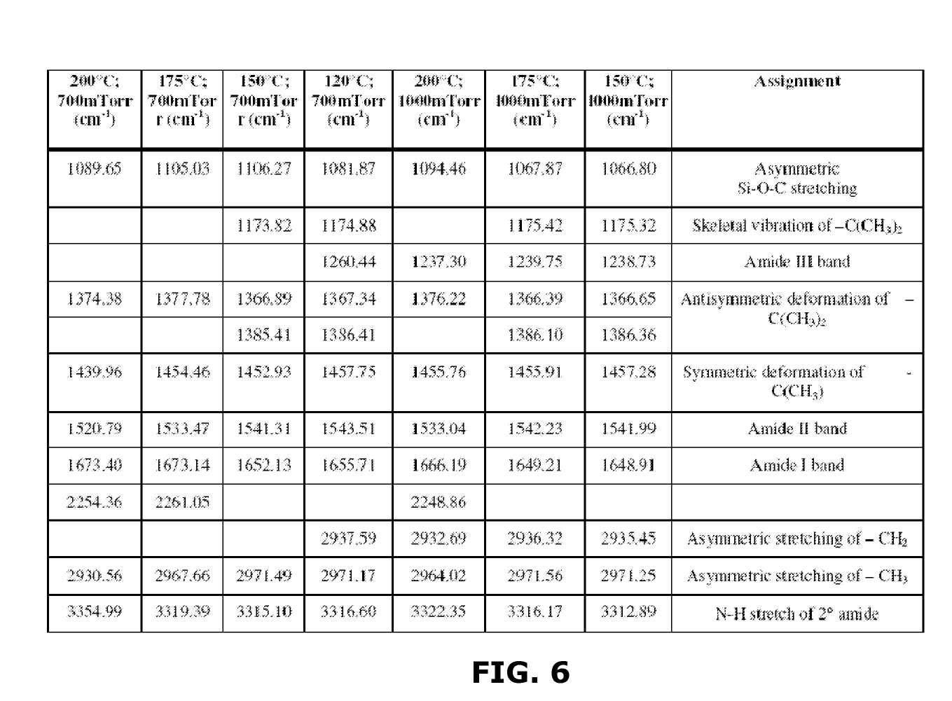

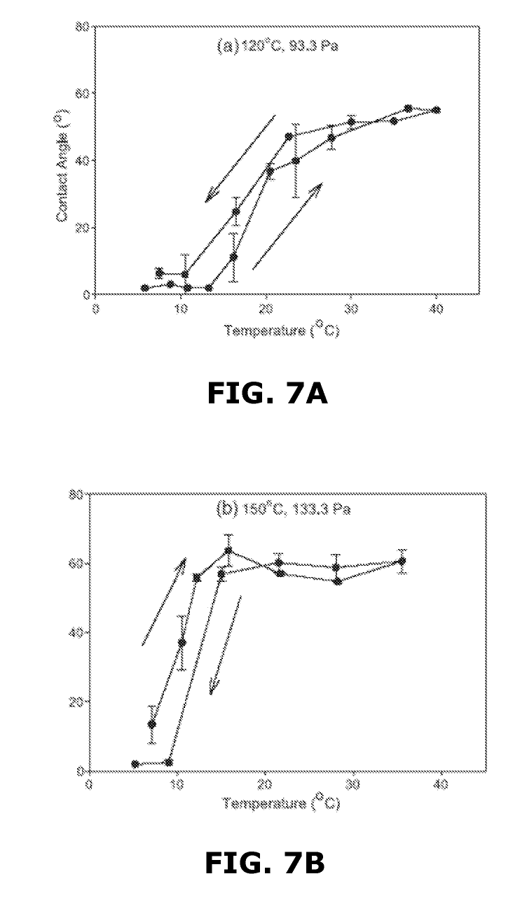

In a second example, the inventors analyzed spectra results of several NIPAAm films formed in accordance with some embodiments of present invention FIG. 4 illustrates a FTIR spectra of NIPAAm films deposited on a silicon substrate in accordance with some embodiments of the invention. FIG. 5 illustrates FTIR spectra, of NIPAAm films deposited on silicon substrate in accordance with some embodiments of the present invention. FIG. 6 illustrates a table displaying FTIR results of NIPAAm films deposited oil silicon in accordance with some embodiments of the present invention.

Chemical composition of the plasma-polymerized NIPAAm thin films were studied using FTIR. Wave numbers of the primary absorption bands and the bonding structures of various samples are provided in FIGS. 4-6. The amide I (˜1640-1680 cm⁻¹) and amide II (˜1520-1540 cm⁻¹) bands associated with C═O stretching and N—H stretching of secondary amides, respectively, are critical to understanding the structure of NIPAAm. These bands are prominent in FTIR spectra of NIPAAm and are sensitive to the degree and type of hydrogen bonding. Deconvolution and second derivative spectroscopy revealed various sub-bands that are shifted to lower wavenumbers as a result of hydrogen bonding with the amide I structure: “free”, non-hydrogen bonded C═O stretching is observed at ˜1670 cm⁻¹; weak intramolecular hydrogen bonded C═O stretches at ˜1655 cm⁻¹; and strong intermolecular hydrogen bonded C═O stretching is observed at ˜1629 cm⁻¹.

The opposite trend was discovered in the case of amide II bands: hydrogen bonding causes the amide II band to shift to higher wavenumbers. The non-hydrogen bonded, “free” band is found at ˜1535 cm⁻¹, the intramolecular hydrogen bonded band at ˜1551 cm⁻¹ and the intermolecular hydrogen bonded band at −1565 cm⁻¹. Analysis of the FTIR spectra of NIPAAm in FIGS. 4-6 based on the trends described above illustrates that deposition at higher temperatures results in NIPAAm films with weak or no hydrogen bonding. This observation is significant from the standpoint of understanding the degree of hydration of NIPAAm films as a result of exposure to the ambient. Films deposited at lower temperatures (120° C. and 150° C.) are more likely to be hydrated by water vapor in the laboratory environment than films deposited at higher temperatures (175° C. and 200° C.).

Absorption bands due to the hydrophobic methyl, methylene and isopropyl groups occur at ˜2969 cm⁻¹, 2932 cm⁻¹, 1451 cm⁻¹, 1365 cm⁻¹ and 1173 cm⁻¹. Existence of bands at 1366, 1386 and 1455 cm⁻¹ is considered proof that the isopropyl group of NIPAAm is preserved and not degraded due to exposure to the plasma environment. Two bands at 1365 cm⁻¹ and 1386 cm⁻¹, which are associated with antisymmetric deformation of the isopropyl group, were observed in all samples deposited at lower temperatures whereas a single band at ˜1377 cm⁻¹, perhaps resulting from merging of the bands at 1365 and, 1386 cm⁻¹, was noted in NIPAAm deposited at higher temperatures. Further, the band at ˜1172 cm⁻¹, associated with skeletal vibration of —C(CH₃)₂ is not observed in NIPAAm films deposited at higher temperatures. These changes signify a general loss of vibrational freedom and are likely associated with the greater crosslinking and conformational order that can be expected in NIPAAm films deposited at higher temperatures. As proof of this trend, the bands at ˜1451 cm⁻¹ (symmetric deformation of —C(CH₃)₂) and 2969 cm⁻¹ (asymmetric stretching of —CH₃) shift toward lower frequencies with increasing deposition temperatures. Furthermore, NIPAAm films deposited at higher substrate temperatures and lower pressures do not show the band at ˜2932 cm⁻¹, which is assigned to the asymmetric stretch of the methylene group found in the backbone of NIPAAm. Absence of this band and, hence, of the methylene group shows that at higher substrate temperatures and lower reactor pressure chain scission may occur.

The absorption band at ˜1080 cm⁻¹, assigned to asymmetric stretching of the Si—O—C bond, has differing widths and is prominent in films deposited at 93.3 Pa only. This suggests the existence of a covalent linkage between the silicon substrate and NIPAAm formed at 93.3 Pa. Although this band is present in NIPAAm films formed at 133.3 Pa, it is weak in comparison to the other prominent bands in the spectra. Such observations are consistent with the reduced ion energy at higher pressures, which results in less bond breaking at the substrate surface as film deposition begins. Evidence of other types of covalent bonding between silicon and NIPAAm films formed at 133.3 Pa is not discernible. The absorption band due to N—H stretching in secondary amides is found at ˜33315 cm⁻¹ in all samples. The amide III band (˜1230 cm⁻¹), which contains contributions from N—H in plane bending and C—N stretching, is present in all samples deposited at 133.3 Pa and in NIPAAm formed at 120° C. and 93.3 Pa. The broad band observed at ˜2250 cm⁻¹ in NIPAAm deposited at 200° C. and 175° C. (93.3 Pa only) has not been assigned to any specific chemical moiety since it is believed to be a combination peak arising from HOE bending modes.

### EXAMPLE 3

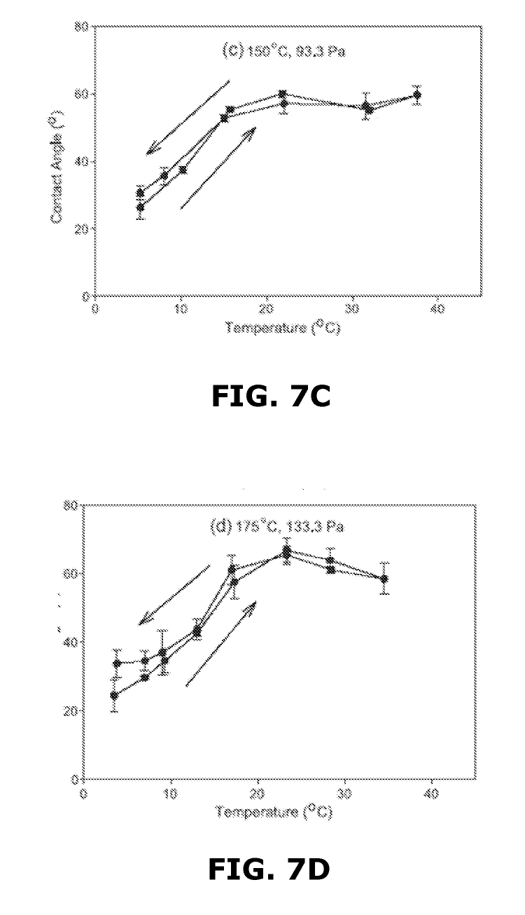

The thermoresponsive behavior of plasma-polymerized NIPAAm films deposited under four different reactor conditions was also investigated using contact angle measurements. FIGS. 7A-7D illustrate various contact angles of plasma-polymerized NIPAAm films deposited on a surface of a silicon substrate in accordance with some embodiments of the present invention. Relatively high deposition rates and low net dissolution of films were important criteria for the choice of samples studied. The dependence of contact angle on sample temperature is shown in FIGS. 7A-7D. Error bars on the contact angle values represent standard deviations from the measurement averages. In all cases nearly reversible thermoresponsive behavior is displayed. The arrows on FIGS. 7A-7D indicate the heating and cooling cycles. While the data points obtained on the heating and cooling cycles are within experimental error, the contact angles measured on the cooling cycle were almost always higher than those on the heating cycle. The contact angles measured on the cooling cycle were obtained after several measurements were made on the heating cycle during which, the sample surfaces were exposed to various organic contaminants in the laboratory environment and from the lint-free tissue used to blot out the droplets of water on the surface.

As FIGS. 7A-7D show, the plasma-polymerized hydrogel thin films undergo a temperature-induced phase transition wherein the affinity of the surface to water changes. At lower temperatures, the surface of plasma polymerized hydrogel films is hydrophilic, but at higher temperatures the surface is less hydrophilic and hence, relatively hydrophobic. In all cases studied, the difference in the water droplet contact angle as a result of the phase transition is at least 35° C. The hydrophilic-hydrophobic transition temperatures for the various samples were determined by numerically differentiating the data and computing the inflection point. In all cases the data of both the heating and cooling cycles were used to determine the inflection point.

The transition temperatures (T_{c}) of the various samples were assigned by averaging the inflection points of the heating and cooling cycles and are as follows: 120° C., 93.3 Pa: 18.2° C.; 150° C. 133.3 Pa: 12° C.; 175° C., 133.3 Pa: 13.7° C.; 150° C., 93.3 Pa: 9° C. The values of T_{c} are significantly lower than that previously known for NIPAAm (approximately 31° C.). These differences can be explained on the basis of the hydrophobic nature of plasma-polymerized NIPAAm. Increasing the hydrophobic content of a hydrogel, for example, by copolymerizing NIPAAm with a hydrophobic monomer, lowers the transition temperature. Indeed, transition temperatures as low as 24.7° C. have been reported for NIPAAm co- and terpolymers based on the degree of hydrophobicity introduced into the hydrogel network through the chromophore used for the polymerization reaction.

Based on FTIR studies, increased hydrophobic character and a partial loss of polar groups in the plasma-polymerized hydrogel network are supported by the lack of significant hydrogen bonding in films deposited at higher temperatures and lower pressures. Films deposited at higher temperatures and lower pressures exhibit chain scission as evidenced by the absence of the FTIR band at ˜2932 cm⁻¹. The transition temperatures obtained for the four samples examined using contact angle goniometry support this trend: samples prepared at lower pressures and higher temperatures show lower T_{c} than films deposited at lower temperatures and higher reactor pressures. Further, the transition of plasma-polymerized hydrogel thin films may be expected to be lower than the reported temperature for bulk poly (NIPAAm) since it was polymerized in the “dry” state. Polymerization and crosslinking in the dry state induces a compressive stress oil the hydrogel network when it is swollen, which contributes to lowering of the transition temperature.

In addition to the trend in transition temperatures, the width of the transition merits attention. In the samples prepared at 120° C., 93.3 Pa and 150° C. 133.3 Pa, the transition is relatively sharp, whereas the transition is nearly continuous in the case of the other two samples as illustrated in FIGS. 7A-7D. Short chains and inhomogeneous networks with a broad distribution of polymer chain lengths between crosslinks yield a continuous transition. Thus, a broad transition can occur in films plasma deposited at lower pressures and higher temperatures. That is, deposition under more energetic conditions can result in extensive chain scission and crosslinking. Therefore, FIGS. 7A-7D indicate that plasma-polymerized hydrogel thin films of NIPAAm exhibit a reversible LCST phase transition since the plasma polymerization conditions allow retention of both hydrophilic and hydrophobic molecular groups that are necessary for the phase transition.

Experimentation Results Summary

During experimentation, the inventors deposited thin films of NIPAAm in a parallel plate, capacitively-coupled RF plasma reactor. Reactor pressure and temperature were varied to improve film adhesion to substrate surface and alter film chemical and physical properties. Films deposited under lower temperature and higher pressure conditions displayed enhanced dissolution in water leading to significant loss in film thickness. NIPAAm films deposited at higher substrate temperatures and lower deposition pressures were more stable in aqueous environments and showed little or no dissolution. Films deposited under appropriate deposition conditions swelled when exposed to water. FTIR spectra of films deposited under different reactor conditions yielded insight into the resulting chemical strictures. Contact angle measurements demonstrated that plasma-polymerized NIPAAm films are capable of exhibiting a reversible LCST transition. By varying the reactor conditions, and hence crosslink density of the films, it is possible to tailor transition temperature of a hydrogel formed with a polymeric structure. Transition temperature may be determined by the physicochemical properties of the hydrogel films. The transition temperature may be quantified through temperature dependent contact angle measurements.

The inventor's experimentation results illustrate that properties of plasma-polymerized hydrogel thin films can be controlled by varying reactor conditions. Indeed, film adhesion to a substrate was successfully achieved by polymerizing NIPAAm under conditions that lead to greater crosslinking and chain scission. Different volume phase transition behavior was observed as a result of minor changes in the chemical composition of the produced hydrogel films. Moreover, the inventor's experimentation results illustrate that plasma polymerization can produce hydrogel thin films with excellent adhesion characteristics without an adhesion promotion layer and also illustrate production of hydrogel films with well-defined phase transition behaviors.

The phase transition behavior in the plasma polymerized NIPAAm confirms the thermoresponsive nature of the hydrogel films formed using the method of the present invention. During plasma polymerization it is possible that the chemical functionalities required for the existence of the phase transition behavior in hydrogels are lost due to bond scission and other degradation reactions. However, in this case, FTIR spectra and temperature dependent contact angle measurements confirmed that no such events occurred, that the original monomer structure was preserved during plasma polymerization, and that the hydrogel films exhibited phase transition behavior characteristic of NIPAAm films produced using other processing methods.

As a result of the phase transition behavior, NIPAAm films can have various applications. First, smart sensors—assemblies of NIPAAm and biomolecules may be used to sense various analytes, which trigger phase transition in the NIPAAm network due to changes in the microenvironment as a result of the sensing event. Second, intelligent surfaces for cell culture—NIPAAm surfaces show different affinites to proteins at different temperatures as a result of the phase transition; below the transition temperature, they prevent protein adhesion whereas above the transition temperature they favor protein adhesion. Consequently, protein mediated cell adhesion may be regulated through the phase transition. Third, bioaffinity separations—based on their variable affinity to biologically important molecules such as proteins, NIPAAm surfaces may capture or release proteins and biomolecules at different temperatures. Fourth, smart drug delivery—NIPAAm films may release drugs in response to environmental stimuli such as temperature and pH by undergoing phase transitions.

The embodiments of the present invention are not limited to the particular formulations, process steps, and materials disclosed herein as such formulations, process steps, and materials may vary somewhat. Moreover, the terminology employed herein is used for the purpose of describing exemplary embodiments only and the terminology is not intended to be limiting since the scope of the present invention will be limited only by the appended claims and equivalents thereof. For example, the temperature, pressure, and power parameters would vary depending on the particular monomer and substrate used. In addition, any monomer capable of polymerization may be used in accordance with embodiments of the present invention.

Therefore, while the various embodiments of this invention have been described in detail with particular reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all equivalents.

We claim:

1. A method to fabricate a crosslinked polymeric structure comprising:
vaporizing a monomer; and
using plasma to polymerize and crosslink the monomer to form a tailored polymer film.

2. The method of claim 1, further comprising varying temperature, pressure, and power conditions associated with polymerizing and crosslinking to form the tailored polymer film.

3. The method of claim 1, further comprising diluting the vaporized monomer using argon, oxygen, nitrogen, anhydrous ammonia, hydrogen, or a combination thereof.

4. The method of claim 1, wherein the monomer comprises at least one of acrylates, acrylamides, acetates, acrylic acids, vinyl alcohols, and glycols.

5. The method of claim 1, wherein the monomer comprises at least one of ethylene glycol, acrylic acid, tetraethyleneglycol dimethylether, and N-isopropylacrylamide.

6. The method of claim 1, further comprising generating the plasma using a parallel-plate, capacitively-coupled, radio-frequency plasma reactor.

7. The method of claim 6, further comprising operating the reactor in a frequency range of about 0.5 MHz to about 30 MHz and in a power range of about 25 W to about 35 W.

8. The method of claim 1, wherein the polymerization and crosslinking of the monomer occurs at a temperature greater than the vaporization temperature of the monomer.

9. The method of claim 1, wherein the plasma is under pressure in a pressure range of about 93.3 Pa to about 133.3 Pa.

10. A crosslinked polymeric structure fabrication method comprising:
providing a plasma reactor; and
introducing plasma within the reactor to deposit a crosslinked polymer film having a tailored crosslink density onto a substrate.

11. The method of claim 10, further comprising activating the substrate to facilitate adhesion of the crosslinked polymer film to the substrate.

12. The method of claim 11, wherein activating the substrate comprises exposing the substrate to plasma to pretreat the substrate for deposition.

13. The method of claim 10, further comprising varying process conditions associated with the plasma reactor to form the crosslinked polymer film having the tailored crosslink density.

14. The method of claim 13, wherein the process conditions comprise at least one of a plasma reactor power factor, a plasma reactor pressure factor, a plasma reactor temperature factor and a substrate temperature factor.

15. The method of claim 10, further comprising exposing the crosslinked polymer film to a liquid to produce one of a responsive hydrogel or an organogel adhered to the substrate.

16. The method of claim 10, further comprising controlling the tailored crosslink density of the polymer film by altering one or more operating parameters associated with the plasma reactor.

17. A crosslinked polymeric structure manufacturing method comprising:
forming a polymer film within a plasma reactor by polymerizing a vaporized monomer such that the polymer film is crosslinked;
depositing the polymer film onto a substrate located within the plasma reactor; and
varying conditions within the plasma reactor to control a crosslink density of the polymer film.

18. The method of claim 17, wherein variable conditions within the reactor comprise a temperature range of between about 120° C. to about 200° C., a pressure range of between about 93.3 Pa to about 133.3 Pa, and a power input of about 30 W.

19. The method of claim 17, wherein the polymer film forms a hydrogel that is reversibly temperature dependent.

20. The method of claim 17, wherein the polymer film forms a hydrogel having a transition temperature ranging from approximately 9° C. to approximately 20° C.
